(19) United States
(12) Patent Application Publication
(10) Pub. No.: US 2007/0292592 A1
(43) Pub. Date: Dec. 20, 2007

(54) Salt replacing composition, process for its preparation and food systems containing such composition

(75) Inventors: Dmitriy V. Zasypkin, Cockeysville, MD (US); Michael A. Porzio, Monkton, MD (US)

Correspondence Address: OBLON, SPIVAK, MCCLELLAND MAIER & NEUSTADT, P.C., 1940 DUKE STREET, ALEXANDRIA, VA, 22314, US

(73) Assignee: McCormick & Company, Sparks, MD (US)

(21) Appl. No.: 11/453,112

(22) Filed: Jun. 15, 2006

(51) Int. Cl. A23L 1/237

(52) U.S. Cl. 426/649

(57) ABSTRACT

A salt replacing composition for replacing sodium chloride in food contains a major amount of potassium chloride, in combination with ammonium chloride, sucrose, one or more of disodium inosinate and disodium guanylate, an organic acid, and a salt of glutamic acid. A reduced sodium chloride composition contains the salt replacing composition and sodium chloride. A food containing the salt replacing composition and a process for making the salt replacing composition.

### BACKGROUND OF THE INVENTION

1. Field of the Invention

The present invention relates to a salt replacing composition. The invention further relates to food, seasonings, and flavorings that contain the salt replacing composition. The invention also relates to a process of flavoring a food by including the salt replacing composition of the invention.

2. Discussion of the Background

Salt in the form of sodium chloride is known to perform multiple functions in foods, including taste enhancement, preservation of foods by suppressing microbial activity and texture modification, as well as many other uses. High sodium intake favors the body's retention of water, which can cause hypertension, a proven risk factor in the development of heart disease, heart failure, strokes, and kidney disease. It has been recently recognized that a reduced level of sodium in foods could lead to a significant reduction in stroke and heart disease.

Many national and international organizations have published advisory guidelines for salt intake. Dietary Guidelines for Americans, jointly published in 2005 by the US Department of Health and Human Services (HHS) and the Department of Agriculture (USDA) state that “on average, the higher an individual's salt (sodium chloride) intake, the higher an individual's blood pressure. Nearly all Americans consume substantially more salt than they need”. The key recommendations include a recommendation to consume less than 2,300 mg of sodium per day (equivalent to about one teaspoon or 5.75 g of salt) and an advice to consume potassium-rich foods including fruits and vegetables. For some specific population groups including individuals with hypertension, individuals of African origin, and middle-aged or older adults the Guidelines recommend consumption of less than 1,500 mg of sodium per day (3.75 g of salt) and a minimum daily potassium intake of 4,700 mg. The best source of potassium is fruits and vegetables, which are rich in potassium in its acidic bicarbonate form.

The European Food Safety Authority (EFSA) estimates that the average individual daily intake of sodium in Europe is 3-5 g (8-11 g salt) while only 1 g of salt per day is required to maintain nutritional balance. The UK Food Standards Agency set a target of bringing down the average UK salt intake to 6 g a day, acknowledging that too much salt is a significant risk factor in developing high blood pressure. According to the UK Food Standards Agency, high blood pressure can triple the risk of heart disease and stroke. The World Health Organization (WHO/FAO, 2005) recommends 5 g of salt as the daily intake limit.

There is a significant need to reduce dietary sodium intake much of which (up to 75%) originates in processed foods manufactured by the food industry and the related food service sector. There is also a need to balance sodium intake with an increased level of potassium.

There have been numerous attempts to address the issue by substituting sodium with potassium or other food salts or acids. Compositions that are used to replace or substitute for sodium chloride are known as salt replacing compositions or sodium chloride replacing compositions. Earlier patents including U.S. Pat. Nos. 1,874,055 and 1,772,183, replaced sodium with acids and acidic salts in various combinations with some success. However, unbalanced sour or chalky notes precluded significant use of such salt substituting compositions.

Other patents have focused on potassium chloride (KCl) as a major component in salt substituting compositions. Depending on concentration and application level, KCl imparts a sour salty sensory perception with very significant metallic and bitter off-notes. Masking of these unacceptable off-notes has become a major challenge and has been attempted with a number of food ingredients, including various salts, organic acids, salts of the organic acids, sweeteners, hydrolyzed vegetable proteins, autolyzed yeasts, amino acids and their salts, most recently salts of nucleic acids.

U.S. Pat. No. 2,471,144 to Davy describes a salt substitute composition containing 66% KCl, 12% NH₄Cl, 17% starch, 3% potassium formate, 1% calcium formate, and 1% magnesium citrate. The composition imparts strong acidity, is moderately salty and, has cardboard and metallic aftertastes.

U.S. Pat. No. 4,243,691 to Mohlenkamp et al. describes a composition containing 33.3% potassium chloride, 26.5% dipotassium orthophosphate, 25.8% hydrolyzed vegetable protein (HVP), 10.5% glucose, 2% 5′-guanosinic acid and 1.9% 5′-inosinic acid. In addition to salty notes the composition has significant umami, some metallic, strong meaty, and slight chalky notes.

U.S. Pat. No. 4,216,244 to Allen describes a low sodium salt seasoning. Two compositions are described in particular: A) 92.4% KCl, 3% L-glutamic acid, 1% monopotassium glutamate (MPG), 1.3% potassium citrate, 1.3% potassium phosphate, 1% anticaking agent; and B) 90.5% formula 1) plus 9.5% lactose. The composition A) significantly masks metallic tastes. However, it also has a sour bite, unbalanced acidity, meaty mid- and after-taste. Composition B), while mitigating some metallic, sour and meaty notes, is far from salty in overall character and imparts lower salt intensity compared to composition A.

U.S. Pat. No. 4,340,614 to Pich, et al., describes a stringently sodium-restricted dietetic salt and its preparation. The composition comprises of 60-85% KCl, 10-30% potassium adipate, 2-5% potassium tartrate, 0.5-2% potassium glutamate, 0.5-2% adipic acid, 0.004-0.06% potassium inosinate and/or potassium guanylate. The composition has low salty taste intensity, imparts significant sour and meaty notes that are especially obvious at the low salt intensity.

EP 0125021 B1 to Kiyoshi et al. describes a seasoning composition containing 100 parts KCl, 1.5-30 parts of calcium salt of organic acid (e.g., calcium lactate), 1-30 parts salt of glutamic acid (e.g., monosodium glutamate (MSG)), or/and 0.01-5 parts of nucleotides (e.g., salts of 5′-inosinate and/or 5′-guanylate). The composition imparts relatively low salt intensity, very significant meaty and slight bitter/metallic notes.

EP 0124254 B1 to Arciszewski at al. describes a salt substitute composition. The composition contains 70-98% KCl, 1-20% nonreducing sugar (sucrose preferred), 0.15-5% anticaking agent (tricalcium phosphate), 0.3-15% organic acid (adipic), 0.5-10% glutamate salt (MPG preferred). The composition has some unbalanced sour, chalky and metallic/meaty notes.

U.S. Pat. No. 5,064,663 to Murray, et al. describes a sodium chloride substitute containing autolyzed yeast and ammonium chloride. The composition contains: A) one part ammonium chloride to about 4 parts autolyzed yeast or B) KCl 0.5 to 20 parts by weight to one part of autolyzed yeast and ammonium chloride mixture as in claim A). The compositions have overpowering meaty notes and some metallic notes.

U.S. Pat. No. 5,853,792 to Zolotov et al. describes a low sodium edible salt composition and process for its preparation. The composition contains 0-50% NaCl, 45-99.5% KCl and at least 0.5% additives, which comprise at least one edible nucleotide monophosphate salt, a burnt sugar, and at least one member other than said nucleotide monophosphate salt for example a low molecular weight organic acid (preferred citric, tartaric, lactic, gluconic and acetic), phosphoric acid (sodium pyrophosphate preferred), phosphate salt, a magnesium salt and sugar. The composition imparts bitter/metallic and meaty notes if taken without sodium chloride. In presence of at least 25% by weight of sodium chloride, the off notes are reduced.

U.S. Pat. No. 6,783,788 to Kuroda et al. describes seasoning compositions, foods containing such a seasoning composition, and a process for preparing such foods. The compositions include 100 parts KCl (potassium chloride), 0.2-5 parts of a sugar alcohol, 1-7.5 parts of MSG (monosodium glutamate), 1-10 parts sucrose, 0.05 to 1 part of sodium inosinate (IMP) and/or sodium guanylate (GMP). Negative sensory attributes imparted by the compositions include strong meaty and slight savory/metallic aftertaste.

WO 2006/013997 A1 to Kuroda et al. describes a seasoning composition, seasoning material and process for producing food therewith. The patent describes the following composition: 100 parts KCl, 1.5-70 parts histidine or salts thereof, 4-100 parts lysine or salts, 2-100 parts of IMP and/or GMP (sodium inosinate and/or sodium guanylate), 20-130 parts of lactic acid or salts, and 5-50 parts of phosphoric acid or salts thereof. The composition has unbalanced meaty and acidic character with some chalky aftertaste.

Evaluations of commercially available salt replacing compositions in solutions and topically on cucumber and/or tomato slices showed unacceptable metallic, bitter or chalky off-notes. Some compositions may have been able to substantially cover metallic and chalky off-notes, however otherwise remained unbalanced in terms of sour, meaty or other savory notes. Other compositions are relatively balanced but exhibit low intensity or uncharacteristic salty character. The unbalanced character of such salt replacing compositions is particularly obvious in some applications. For example, seasonings applied on potato chips are especially sensitive to even subtle bitter/metallic notes.

While it is apparent that some salt replacing compositions may be able to perform satisfactorily in some applications, a broadly acceptable salt replacing compositions or one that provides desirable taste characteristics over a broad spectrum of foods has not been found. Existing salt replacing compositions are unable to mitigate unacceptable metallic/bitter notes without significantly unbalancing the true salty character. There is a need for improved salt replacing compositions having desirable taste characteristics.

### SUMMARY OF THE INVENTION

Accordingly, it is one object of the present invention to provide a salt replacing composition.

It is another object of the invention to provide a salt replacing composition that can efficiently mask metallic/bitter notes of potassium chloride, enhance salty character, and increase the intensity of the true salty taste while keeping the overall taste balanced.

It is another object of the invention to provide a salt replacing composition that may be efficiently used as a sodium chloride/table salt replacer for topical and/or ingredient mix applications.

It is another object of the invention to provide condiments and intermediate food preparations such as dough, minced meat, cheese curd, coatings and other food products containing a salt replacing composition.

It is another object of the invention to provide a salt replacing composition that reduces sodium and increases potassium level in foods.

It is another object of the invention to provide a reduced salt seasoning composition having a decreased amount of sodium and an increased amount of potassium in comparison to sodium chloride.

It is another object of the present invention to provide a process for preparing a salt replacing composition, which controls the degree of mixing of the components, structure and size of particles of the salt replacing composition.

It is another object of the invention to provide a process for controlling the impact of salty taste, enhancing the masking of undesirable off-notes and/or improving salty character in seasonings.

It is another object of the present invention to provide foods, which include a salt replacing composition or a reduced salt composition and have a good, intense and balanced salty taste and reduced sodium and increased potassium content.

These objects, as it will become apparent in the following detailed description, have been achieved by the inventors' discovery that in certain salt replacing compositions the metallic/bitter off-notes of potassium chloride can be efficiently masked, the salty character enhanced, the salty taste intensity can be increased and balanced, to the extent the composition can efficiently replace sodium chloride/table salt in various final and intermediate food applications. The inventors discovered that a synergistic sensory interaction of ammonium chloride, monopotassium glutamate and combined disodium inosinate/disodium guanylate not only masked bitter/metallic notes of potassium chloride but that also enhanced true salty character and salt intensity. The effect has been achieved at significantly lower levels of components other than potassium chloride compared to conventional salt replacing compositions that contain such components. It was further discovered that sugar, an organic acid and/or salt thereof may additionally help to balance the composition. True balanced salty character was found to dominate in a wide range of application levels of the salt replacing composition of the invention.

### DETAILED DESCRIPTION OF THE PREFERRED EMBODIMENTS

In one embodiment, the present invention provides a salt replacing composition which can eliminate or reduce the amount of sodium chloride in food, seasonings or flavorings and provide a good salty taste to food.

In embodiments, the salt replacing composition of the invention may comprise:
(a) 75-95%, preferably, 80-90% by weight of potassium chloride;
(b) 3-15%, preferably, 6-10% by weight of ammonium chloride;
(c) 1-15%, preferably, 2-8% by weight of a sweetener;
(d) 0.4-5%, preferably, 0.75-3% by weight of disodium inosinate and/or disodium guanylate (based on anhydrous form);
(e) 0.1-5%, preferably, 0.2-3% of organic acid or a salt of organic acid (based on anhydrous form); and
(f) 0.05-2%, preferably, 0.1-0.9% by weight of a salt of glutamic acid (based on anhydrous form).

The salt replacing compositions imparted intense and balanced salty character in solutions and in many foods including topically on cucumbers and tomatoes, in seasonings applied to chips, coatings applied to fried meats, in soups and gravies, in mashed green beans and other food applications.

A most preferred salt replacing composition, when compared to other naturally occurring, patented, or conventional compositions at the same level of salt or sodium reduction in foods, provides a more intense salty taste and better balanced sensory attributes similar to those of table salt versions of the foods.

The salt replacing composition of the present invention may exist as a powder, granular blend, or a liquid, and may occur as one component of a mixture of components such as a final food or intermediate food prepared with this salt replacing composition.

Potassium chloride is a major component of the salt replacing composition of the invention. It provides salty and sour attributes to the composition, balance of which depends on potassium chloride concentration. It also comes with known metallic/bitter off notes which are highly undesirable and have to be mitigated. Potassium chloride is also a source of potassium ions that are recommended in a diet to counterbalance an excessive amount of sodium.

As a major component of the salt replacing composition, potassium chloride may be the single component that is present in the highest amount when calculated based on the weight of the potassium chloride relative to the weight of the total composition. Alternatively, potassium chloride may be present as a major component where potassium chloride represents at least 50 wt % based on the weight of the potassium chloride in comparison to the weight of the entire composition. Preferably, the potassium chloride is present in an amount of at least 50 wt %, more preferably potassium chloride is present in an amount of at least 55 wt %, even more preferably, 60 wt %, even more preferably 65 wt %, especially preferably 70 wt %, even more especially 75 wt %. In other embodiments, potassium chloride is present in an amount of 80 wt %, 85 wt %, 90 percent, 95 wt %, or 99 wt %. When percent by weight (wt %) is calculated, the amount of inert, non-flavoring components is not included in the total weight of the composition.

The potassium chloride can be in any purified form including powder, granule, solution, dispersion or slurry. Food grade materials rich in potassium chloride can also be used as a source of potassium chloride. The source can be from purified mineral deposits as well as from sea water bittern as an example.

Ammonium chloride is present in the salt replacing composition of the invention. The ammonium chloride may impart a salty and sour taste. In the amounts used in the salt replacing composition, ammonium chloride does not introduce any off-notes and helps to reduce metallic/bitter off notes imparted by potassium chloride. In combination with salts of glutamic acid and disodium inosinate/disodium guanylate it synergistically enhances salty character and increases the salt intensity of the salt replacing composition. The synergistic effect permits lower amounts of the components to be used while still enhancing salty character and masking bitterness originating from potassium chloride.

Ammonium chloride in the composition can be in any purified food grade form. Most common form is the anhydrous crystalline form. Ammonium chloride can also be used as a solution, dispersion or concentrated slurry. Food grade ammonium chloride is produced by the reaction of sodium chloride and an ammonium salt in solution. The less soluble sodium salt separates out at elevated temperatures, and ammonium chloride is recovered from filtrate on cooling. Alternatively, hydrogen chloride formed by the burning of hydrogen in chlorine is dissolved in water and then reacted with gaseous ammonia. Then ammonium chloride is crystallized from the solution. Ammonium chloride meets the specifications of the Food Chemicals Codex, 3d Ed. (1981) p. 20, which is incorporated by reference. According to the Code of Food Regulations (CFR) v.21, paragraphs 184.1(b) (1) and 184.1138, incorporated herein by reference, ammonium chloride can be used in food with no limitation other than current good manufacturing practice. More specifically, in the salt replacing composition of this patent ammonium chloride is used as a flavor enhancer.

Sweeteners include any sugar, e.g., sucrose, dextrose, lactose, maltose, fructose, trehalose, and mannose, sugar alcohol including mannitol, maltitol, erythritol, xylitol, sorbitol, palatinol, corn syrup solids having a dextrose equivalent above or equal 24 and hydrogenated corn syrup solids. High intensity sweeteners including aspartame, potassium acesulfame, cyclamate, saccharin, sucralose, neotame, and others can be used in concentrated or diluted form as a sweetener. The sweetener in the salt replacing composition can be a combination of the sweeteners listed above. The most preferred sweetener in the composition is sucrose.

The sucrose present in the salt reducing composition may function to balance the taste, somewhat masking bitterness and excessive sour taste, and enhancing salty character. Sucrose is a non-reducing sugar and is less reactive compared to other sugars in when considered as part of a composition that includes the salts of amino acids and ammonium chloride, all known to react with reducing sugars. Sucrose may provide longer shelf-life to the salt replacing composition when in the form of a dry blend and assures stability and better functionality of the composition in heated food applications containing moisture. Sucrose can be in any form including granulated sugar, brown sugar, and soft sugar, for example. Highly purified crystalline sugar is preferred for most food applications.

Disodium inosinate can be used individually or in a combination with disodium guanylate. These components of the salt replacing composition are also known as inosine 5′-monophosphate disodium salt or guanosine 5′-monophosphate disodium salt hydrate, respectively. Alternatively, the ingredients can be named 5′-inosinic acid disodium salt hydrate or 5′-guanylic acid disodium salt hydrate, respectively. Potassium or ammonium salts of the inosinic or guanosinic acids may be used in a salt replacing composition.

Both components work synergistically with ammonium chloride and salts of glutamic acid to enhance the salty character of potassium chloride while masking its bitter/metallic off-notes in the salt replacing composition of the invention. Hydrate crystal forms of disodium inosinate and disodium guanylate can be used.

Organic acids may include any of citric, tartaric, succinic, malic, lactic, fumaric, adipic, and ascorbic acids. Their acidic salts include sodium, potassium, and calcium salts and their hydrate crystal forms. The preferred organic acid is citric acid, while most preferred salts of organic acids include various sodium or potassium salts of citric acid and potassium bitartrate also known as cream of tartar. Organic acids or their salts can be in a powder, granular, or liquid form.

Hydrate crystal forms of organic acids or their salts can be used. Organic acids or their salts can also be used individually or in a combination.

Salts of glutamic acid used in the present salt replacing composition include monosodium glutamate and monopotassium glutamate and hydrate crystal forms thereof. The salts of glutamic acid work synergistically with ammonium chloride and a combination of disodium inosinate and disodium guanylate to mask metallic/bitter notes of potassium chloride and enhance its salty character and salt intensity in the salt replacing composition of the invention. Monopotassium glutamate is the most preferred form due to the fact that the salt provides less meaty notes and more balanced salty character to the composition.

A flow agent can be optionally added to the salt replacing composition or any component of the salt replacing composition and selected, for example, from silicon dioxide, fumed silica, sodium alumino silicate, basic magnesium carbonate, tricalcium phosphate, magnesium oxide, calcium silicate, powdered and crystalline cellulose, sodium ferrocyanise, and starch.

A flavor can be added to the salt replacing composition to enhance the salty character of the composition in a specific food application, help to balance the overall flavor and/or to additionally mask some undesirable notes resulted from sensorial interaction of ingredients in the food. The term flavor includes spice oleoresins and oils derived from any of allspice, basil, capsicum, cinnamon, cloves, cumin, dill, garlic, marjoram, nutmeg, paprika, black pepper, rosemary and turmeric; essential oils including anise oil, caraway oil, clove oil, eucalyptus oil, fennel oil, garlic oil, ginger oil, peppermint oil, onion oil, pepper oil, rosemary oil, and spearmint oil; citrus oils such as orange oil, lemon oil, bitter orange oil and tangerine oil; alliaceous flavors including garlic, leek, chive, and onion; botanical extracts including arnica flower extract, chamomile flower extract, hops extract, and marigold extract; botanical flavor extracts including blackberry, chicory root, cocoa, coffee, kola, licorice root, rose hips, sassaparilla root, sassafras bark, tamarind, licorice, and vanilla extracts; protein hydrolysates including hydrolyzed vegetable protein (HVPs), autolyzed yeast, meat protein hydrolysates, milk protein hydrolysates; and compounded flavors both natural and artificial including those disclosed in S. Heath, Source Book of Flavors, Avi Publishing Co. Westport, Conn., pp. 149-277, 1981, which is incorporated herein by reference in its entirety. Representative flavor compounds include benzaldehyde, diacetyl(2,2-butanedione), vanillin, ethyl vanillin and citral(3,7-dimethyl-2,6-octadienal).

A flavor adjuvant or flavor enhancer can be optionally added to the composition to further enhance the salty character of the composition in a specific food application, help to balance the overall flavor or additionally mask some undesirable notes resulted from sensorial interaction of ingredients in the food. Flavor adjuvants or flavor enhancers can include various classes of food additives including organic acids, fatty acids, salts of organic acids, and emulsifiers.

An emulsifier can be optionally added to further improve salty character of the composition in some applications. Emulsifiers include distilled monoglycerides, ethoxylated monoglycerides, lactylated monoglycerides, acetylated monoglycerides, diacetyl tartaric acid esters of monoglycerides (D.A.T.E.M.'s), propylene glycol mono esters, sorbitan mono stearate, sorbitan tristearate, polyglycerol esters of fatty acids, sorbitan polyoxyethylene monoester and triesters, sucrose esters, sodium stearoyl lactylate (S.S.L.), lecithin, hydroxylated lecithin, oleyl lactylic acid, lactylated esters of monoglycerides, lactylated esters of propylene glycol and monoglycerides, sodium lauryl sulfate, cetyl pyridinium salt, and the sodium and potassium salts of fatty acids singly or in combination. The emulsifier(s) may be present in an amount of up to 0.5% in the salt replacing composition. Sodium lauryl sulfate is a preferred emulsifier. Potassium iodide may be added to provide a micronutrient that is necessary in the diet.

The salt replacing composition can be blended at any ratio with sodium chloride to achieve any desirable salt or sodium reduction. Sodium chloride improves the salty character and intensity of the salt replacing composition.

When used as a dry blend, the salt replacing composition may have components with comparable particle sizes to avoid segregation of the components. The components in some cases may be ground, milled or otherwise processed to bring the particles or fractions to the desired size tailored to an application for the desired kinetics of taste and aroma impact. The salt replacing composition to be used as a table salt preferably will have particles in the range between 20 to 60 mesh of US Standard sieve size.

The invention also provides a process for preparing the salt replacing composition or the reduced salt composition. The salt replacing compositions can be prepared by straight blending of the components. In addition, whenever smaller particles are desired, the components can be co-milled, dissolved or dispersed and dried, for example, spray-dried, ball milled or otherwise reduced by any of the available techniques. If larger particles are desired, an agglomeration and/or a coating process including fluidized bed coating, or an extrusion process combined with drying and milling may be used.

In a further embodiment, the invention provides a food having reduced sodium chloride/sodium content and an intense balanced salty taste, and containing the salt replacing composition or the seasoning composition of the invention.

Examples of foods which may include the present salt replacing or seasoning composition include any food to which sodium chloride is added to enhance the salty taste and/or the flavor in general. Such foods include but are not limited to soups, snacks, foods with a coating, condiments (including sauces, rubs, marinades, dressings, salsas, and the like), meats, vegetables, fruits, cereals, processed foods, flavored seasonings, ingredient blends and flavorings.

Other details and features of the compositions described in the present invention will be more apparent from the exemplary embodiments, which are provided for illustration of the invention and are not intended to be limiting thereof.

### EXAMPLES

The following examples further illustrate the preferred embodiments and functionality of the salt replacing and seasoning compositions.

Example 1: 400 g of solids made up of 86.4% by weight potassium chloride, 7.77% ammonium chloride, 3.83% sucrose, 1.25% disodium inosinate (IMP)/disodium guanylate (GMP) blend (about 1:1 IMP/GMP blend by weight), 0.5% citric acid, and 0.25% monopotassium glutamate (MPG) were mechanically blended and shaken in a closed container to form a salt replacing composition.

Aqueous solutions of various concentrations of the salt replacing composition were prepared in the range from 0.5% by weight to 2% and a taste panel ranked salty, sour, umami and bitter/metallic by their comparative intensity/impact at each of the concentration. Rank scale was from 1 for the highest relative intensity to 4 for the lowest one out of four taste attributes typical for the salt replacers. There were on average six panelists participating in a taste panel. Only one concentration of the salt replacing composition was evaluated per panel. Two reference solutions were prepared (by weight): 1.5% potassium chloride for bitter/metallic note and a mixed solution of 0.042% IMP/GMP with 0.009% MPG for umami note. The results are summarized in Table 1.

TABLE 1

| Salt replacer | | | | BITTER/ |
|---|---|---|---|---|
| concentration | SALTY | SOUR | UMAMI | METALLIC |
| % w/w | Average | Average | Average | Average |
| 0.5 | 2.2 | 3.6 | 1.8 | 2.4 |
| 1 | 2.3 | 3.0 | 2.3 | 2.3 |
| 1.5 | 1.2 | 3.8 | 2.2 | 2.8 |
| 2 | 1.3 | 2.8 | 3.2 | 2.7 |

The data show that in the salt replacing composition, at lower concentrations, umami notes compete with salty taste, however, salt intensity takes over above 1% in solution, balances the composition and provides good intense salty perception. Bitter/metallic note remains low and below threshold even at lower concentrations of the salt replacer.

Ammonium chloride in combination with low levels of IMP/GMP and MPG, and other components in the composition synergistically enhances salty character of potassium chloride and efficiently mitigate its bitter/metallic notes.

### Example 2

In this example, the umami component was further reduced compared to the composition of the Example 1. 400 g of solid components made up of 86.76% potassium chloride, 7.8% ammonium chloride, 3.84% sucrose, 0.98% disodium inosinate (IMP)/disodium guanylate (GMP) blend (about 1:1 IMP/GMP blend by weight), 0.5% citric acid, and 0.12% monopotassium glutamate (MPG) were mechanically blended and shaken in a closed container to form a salt replacing composition.

The sensory evaluation described in the Example 1 was repeated for Example 2. The results are summarized in Table 2.

TABLE 2

| Salt replacer | | | | BITTER/ |
|---|---|---|---|---|
| concentration | SALTY | SOUR | UMAMI | METALLIC |
| % w/w | Average | Average | Average | Average |
| 0.5 | 3 | 3.6 | 2 | 1.4 |
| 1 | 2.7 | 3 | 2.3 | 2 |
| 1.5 | 1.8 | 4 | 2.2 | 2 |
| 2 | 1.3 | 3 | 3.2 | 2.5 |

The data show that at lower concentrations of the salt replacing composition bitter/metallic or and umami notes overpower the salty character, however, at concentrations above 1% in solution, salt intensity becomes dominant, balances the composition and provides good intense salty perception at much lower level of the umami components in the composition. Bitter/metallic note is mitigated more efficiently above 1.5% of the composition.

### Example 3

In this example, the sour component was enhanced compared to the composition of Example 2. 400 g of solid components made up of 86.26% potassium chloride, 7.8% ammonium chloride, 3.84% sucrose, 0.98% disodium inosinate (IMP)/disodium guanylate (GMP) blend (about 1:1 IMP/GMP blend by weight), 1% citric acid, and 0.12% monopotassium glutamate (MPG) were mechanically blended and shaken in a closed container to form a salt replacing composition.

The sensory evaluation described in the Example 1 was repeated for Example 3. The results are summarized in Table 3.

TABLE 3

| Salt replacer | | | | BITTER/ |
|---|---|---|---|---|
| concentration | SALTY | SOUR | UMAMI | METALLIC |
| % w/w | Average | Average | Average | Average |
| 0.5 | 2.8 | 2.6 | 2 | 2.6 |
| 1 | 2.2 | 3.3 | 2 | 2.5 |
| 1.5 | 1.2 | 3 | 2.4 | 3.4 |
| 2 | 2.2 | 1.7 | 3.2 | 3 |

The data show that at lower concentrations of the salt replacing composition umami intensity competes with salt. However, bitter/metallic remains at the lower levels even at the lowest levels of umami components. This indicates that the increased level of acidic component does contribute to the bitter/metallic mitigation of potassium chloride at low levels of the umami components induced by IMP/GMP in combination with MPG. At 1.5% of the salt replacing composition the salty character dominates over all other sensory attributes. The salty character is overpowered by sour notes at 2% and above.

### Example 4

400 g of solid components made up of 85.90% potassium chloride, 7.81% ammonium chloride, 3.85% sucrose, 1.26% disodium inosinate (IMP)/disodium guanylate (GMP) blend (about 1:1 IMP/GMP blend by weight), 0.93% potassium bitartrate (cream of tartar), and 0.25% monopotassium glutamate (MPG) were mechanically blended and shaken in a closed container to form a salt replacing composition.

Sensory evaluation shows close match with the salt replacing composition of the Example 1 with less intense sour component at the concentrations of the composition above 1.5%.

### Example 5

400 g of solid components made up of 86.22% potassium chloride, 7.84% ammonium chloride, 3.86% sucrose, 0.99% disodium inosinate (IMP)/disodium guanylate (GMP) blend (about 1:1 IMP/GMP blend by weight), 0.93% potassium bitartrate (cream of tartar), 0.12% monopotassium glutamate (MPG), and 0.04% of a flavor enhancer containing 0.3% of sodium lauryl sulfate were mechanically blended and shaken in a closed container to form a salt replacing composition.

Sensory evaluation shows good salty character with slightly reduced salt intensity as well as reduced meaty/umami note, compared to the salt replacing composition of the Example 4. However, when seasoning compositions comprising of 10, 20, 30, and 40% of sodium chloride and 90, 80, 70, and 60% by weight of the salt replacing composition, respectively, were evaluated in combination with 0.04% by weight of the flavor enhancer the compositions show an increased salt intensity and better salty character compared to the same blends prepared without the flavor enhancer. On average 5 of 6 panelists on the panel described the results as favorable.

### Example 6

The salt replacing composition of the Example 1 was compared against a commercially available composition Saltless comprising potassium chloride, monopotassium glutamate, glutamic acid, tricalcium phosphate, and 0.01% by weight of potassium iodide. English cucumber slices were topically seasoned with 0.1 g of the compositions and compared side by side by eight panelists routinely participating in sensory panels. The paired forced choice sensory panel required to choose a sample with the higher salt intensity and give preference to a sample. All panelists indicated that the salt replacing composition of Example 1 was more salty. Seven out of eight panelists preferred the same composition. One panelist did not like the composition on the basis of too strong salty impact. The same panel test was run on Roma tomato slices. Seven out of nine panelists identified the slices seasoned with the salt replacing composition of the Example 1 as more salty, the preference being a split: five panelists preferred the samples seasoned with Saltless apparently due to variability in bitter/green notes coming from the tomato slices in the aftertaste according to the comments.

### Example 7

The salt replacing composition of the Example 1 was compared against a composition described in U.S. Pat. No. 6,783,788 comprising by weight 100 parts of potassium chloride, 3 parts of monosodium glutamate, 1.5 part of sorbitol, 2 parts of sugar, and 0.2 parts of disodium inosinate. English cucumber slices were topically seasoned with 0.1 g of the compositions and compared side by side by nine panelists routinely participating in sensory panels. The paired forced choice sensory panel requested a sample with the higher salt intensity to be chosen and give preference to a sample. Six panelists indicated that the salt replacing composition of the Example 1 was more salty. Five panelists preferred the same composition.

### Example 8

400 g of solid components made up of 86.72% potassium chloride, 7.80% ammonium chloride, 3.84% sucrose, 0.98% disodium inosinate (IMP)/disodium guanylate (GMP) blend (about 1:1 IMP/GMP blend by weight), 0.50% anhydrous citric acid, 0.12% monopotassium glutamate (MPG), and 0.04% of a flavor enhancer containing 0.3% of sodium lauryl sulfate were mechanically blended and shaken in a closed container to form a salt replacing composition.

Plain potato chips containing no seasoning were warmed up in a bag in microwave oven and seasoned with a blend of sodium chloride/salt replacing composition. The blend was made to reduce sodium content from 180 mg of sodium per serving in the full salt control chips down to 80 mg of sodium per serving in the experimental chips. Four trained panelists scored the experimental chips an average score of 2.8 compared to 3.0 for the full salt control, which was considered a close and acceptable match.

### Example 9

A number of reduced sodium compositions were compared using commercially available cooked pureed green beans as a model food preparation (Table 4). The green beans did not contain sodium. All of the compositions were used at 0.5% by weight in beans. The first composition was granular salt used as a control. Two other compositions were variations of sea salt. Another composition was a 1:1 blend by weight of sodium chloride and potassium chloride. Three compositions were 1:1 blends of sodium chloride and the salt replacing compositions disclosed in the Examples 1, 2, and 8 of this patent. A panel of 8 trained descriptive panelists evaluated the green beans containing the reduced sodium compositions, using a degree of difference scale from 1 to 10, where 9-10 was a match to the full salt control. The salt replacing composition of the Example 1, mixed with the equal weight of sodium chloride scored the highest in the food at 50% by weight of sodium reduction.

TABLE 4

| | SODIUM, | |
|---|---|---|
| SAMPLE | mg/serving | SCORE |
| SALT GRANULAR, CONTROL | 393.1 | 10 |
| REDUCED SODIUM SEA SALT | 193 | 7.4 |
| LOW SODIUM SEA SALT | 160 | 6.8 |
| NaCl/KCl 1:1 | 198.5 | 7.1 |
| COMPOSITION OF EXAMPLE 1/NaCl 1:1 | 196.5 | 8.2 |
| COMPOSITION OF EXAMPLE 8/NaCl 1:1 | 196.5 | 7.2 |
| COMPOSITION OF EXAMPLE 2/NaCl 1:1 | 196.5 | 6.9 |

As shown by the data above, the salt replacing composition of the invention has substantially superior taste and flavor characteristics in comparison to know salt replacing compositions and/or salt substitutes.

What is claimed is:

1. A sodium chloride replacing composition, comprising:
75-95% by weight of potassium chloride,
3-15% by weight of ammonium chloride,
1-15% by weight of sucrose,
0.4-5% by weight based on anhydrous form of disodium inosinate, disodium guanylate or a mixture thereof,
0.1-5% by weight of a low molecular weight organic acid, a mixture of organic acids or their salts other than salts of glutamic acid, and
0.05-0.9% by weight of a salt of glutamic acid or mixtures of such salts,
wherein % by weight is based on the total weight of the composition.

2. The salt replacing composition of claim 1, comprising:
80-90% by weight of potassium chloride,
6-10% by weight of ammonium chloride,
2-8% by weight of sucrose,
0.5-3% by weight based on anhydrous form of disodium inosinate, disodium guanylate or mixture thereof,
0.2-3% by weight of the low molecular weight organic acid, mixture of organic acids or their salts other than salts of glutamic acid, and
0.1-0.7% by weight of a salt of glutamic acid or mixtures of such salts.

3. A table salt comprising the salt replacing composition of claim 1.

4. The table salt of claim 3, containing no sodium chloride.

5. The salt replacing composition of claim 1, comprising disodium inosinate and disodium guanylate wherein each of disodium inosinate and disodium guanylate are in a hydrate crystal form.

6. The salt replacing composition of claim 1, where the organic acid is at least one selected from the group consisting of citric, tartaric, succinic, malic, lactic, fumaric, adipic, and ascorbic acid.

7. The salt replacing composition of claim 6, wherein the organic acid is in the form of at least one of a sodium salt, a potassium salt and a calcium salt.

8. The salt replacing composition of claim 7, wherein the salt of the organic acid is in a hydrate crystal form.

9. The salt replacing composition of claim 1, comprising citric acid.

10. The salt replacing composition of claim 1, comprising potassium bitartrate.

11. The salt replacing composition of claim 1, comprising a glutamic acid salt in a hydrate crystal form.

12. The salt replacing composition of claim 1, further comprising:
up to 0.5% of at least one of a taste enhancing and a masking agent selected from the group consisting of a flavor, a flavor adjuvant, a flavor enhancer, an emulsifier and mixtures thereof.

13. The salt replacing composition of claim 12, comprising sodium lauryl sulfate.

14. A reduced salt composition, comprising:
the salt replacing composition of claim 1 and from 1% to 99% by weight of sodium chloride.

15. A reduced salt composition, comprising:
the salt replacing composition of claim 9 and sodium chloride, wherein the sodium chloride is present in an amount of from 1% to 99% by weight based on the total weight of the reduced salt composition.

16. A process for preparing the salt replacing composition of claim 1, comprising:
at least one of impact milling, ball milling and jet milling, spray drying of solubilized components, fluidized bed coating of potassium chloride granules with solubilized components of the composition other than the potassium chloride, agglomerating and extruding, carried out on a mixture comprising the sodium chloride replacing composition to control the degree of mixing, structure and size of particles of the salt replacing composition.

17. A process for preparing the salt replacing composition of claim 12, comprising:
at least one of impact milling, ball milling and jet milling, spray drying of solubilized components, fluidized bed coating of potassium chloride granules with solubilized components of the composition other than the potassium chloride, agglomerating and extruding, carried out on a mixture comprising the sodium chloride replacing composition to control the degree of mixing, structure and size of particles of the salt replacing composition.

18. A process for preparing the reduced salt composition of claim 14, comprising:
at least one of impact milling, ball milling and jet milling, spray drying of solubilized components, fluidized bed coating of potassium chloride granules with solubilized components of the composition other than the potassium chloride, agglomerating and extruding, a mixture comprising the sodium chloride replacing composition to control the degree of mixing, structure and size of particles of the salt replacing composition.

19. A food containing the salt replacing composition of claim 1.

20. A food containing the salt replacing composition of claim 12.

21. A food containing the reduced salt composition of claim 14.
